(19) United States
(12) Patent Application Publication
(10) Pub. No.: US 2008/0259911 A1
(43) Pub. Date: Oct. 23, 2008

(54) Methods and Apparatus for Distributing and Acquiring Overhead Flow Data in a Multi-Frequency Network

(76) Inventors: Binita Gupta, San Diego, CA (US); An Mei Chen, San Diego, CA (US); Sajith Balraj, San Diego, CA (US); Prasanna Kannan, San Diego, CA (US)

Correspondence Address: QUALCOMM INCORPORATED, 5775 MOREHOUSE DR., SAN DIEGO, CA, 92121, US

(21) Appl. No.: 12/051,218

(22) Filed: Mar. 19, 2008

Related U.S. Application Data
(60) Provisional application No. 60/896,251, filed on Mar. 21, 2007.

(51) Int. Cl. H04L 12/66

(52) U.S. Cl. 370/356

(57) ABSTRACT

Methods and apparatus for distributing and acquiring overhead flow data in a multi-frequency network. In an aspect, a method includes generating initial acquisition flows (IAFs) that describe how content multiplexes are distributed in the multi-frequency network and provide flow identifiers for overhead flows associated with the content multiplexes, and transmitting the IAFs on pre-assigned flow identifiers. Another method includes receiving IAFs that describe how content multiplexes are distributed in the multi-frequency network and specify flow identifiers for overhead flows associated with the content multiplexes, wherein the IAFs are received using pre-assigned flow identifiers, processing the IAFs to determine VM sets associated with current wide and local areas of the multi-frequency network, determining overhead flow related information associated with selected content multiplexes in the VM sets, and acquiring overhead flow data associated with the selected content multiplexes using the associated flow identifiers.

### CLAIM OF PRIORITY UNDER 35 U.S.C. §119

The present application for patent claims priority to Provisional Application No. 60/896,251 entitled “Method and Apparatus for Distributing Overhead Flow Data for a Multiple-Frequency Network,” filed Mar. 21, 2007, and assigned to the assignee hereof and hereby expressly incorporated by reference herein.

### BACKGROUND

1. Field

The present application relates generally to the operation of data networks, and more particularly, to methods and apparatus for distributing and acquiring overhead flow data in a multi-frequency network.

2. Background

Data networks, such as wireless communication networks, have to trade off between services customized for a single terminal and services provided to a large number of terminals. For example, the distribution of multimedia content to a large number of resource limited portable devices (subscribers) is a complicated problem. Therefore, it is important for network operators, content retailers, and service providers to have a way to distribute content and/or other network services in a fast and efficient manner and in such a way as to increase bandwidth utilization and power efficiency.

A multi-frequency network (MFN) is a network in which multiple radio frequencies (RFs) (or RF channels) are used to transmit media content. One type of MFN is a horizontal multi-frequency network (HMFN) where a distribution waveform is transmitted over different RF channels in different local areas. The same or different content may be transmitted as part of distribution waveforms carried over different RF channels in such local areas. Another type of MFN is a vertical multi-frequency network (MFN) in which multiple radio frequency (RF) channels are used in a given local area to transmit independent distribution waveforms with an aim to increase the capacity of the network (in terms of the ability to deliver more content to a device/end user). An MFN deployment may also consist of VMFN in certain areas and HMFN in certain other areas.

In a typical HMFN, a local operations infrastructure (LOI) comprises transmitting sites that operate to transmit a single distribution waveform over an RF channel in a given local area. In a vertical MFN, multiple RF channels are used to convey multiple distribution waveforms carrying different content in a given local area. In an MFN, content is transmitted on one or more RF channels along with associated overhead information. The overhead information associated with the content provides control and signaling to receiving devices to allow them to select, receive and decode desired content on the device. The overhead information is transmitted as part of overhead flows.

Overhead flow data transmitted along with the content may be different in different geographic regions based on the set of content being carried in those geographic regions. A device needs to acquire the appropriate set of overhead flow data associated with content being transmitted in the device's current region to be able to select, receive and decode available content. Thus, efficient distribution of content and associated overhead information over multiple areas and multiple RF channels in a multi-frequency network is important to facilitate acquisition by receiving devices. For example, devices moving into new regions of a multi-frequency network need to acquire the appropriate set of overhead flow data within that region to identify and acquire available content.

Therefore, it would be desirable to have a distribution mechanism that operates to efficiently distribute overhead flow data over multiple regions and multiple RF channels in a multi-frequency network.

### SUMMARY

In one or more aspects, an overhead flow data distribution system, comprising methods and apparatus, is provided that operates to efficiently distribute overhead flow data over a multi-frequency network.

In an aspect, a method is provided for overhead flow data distribution in a multi-frequency network. The method comprises generating initial acquisition flows (IAFs) that describe how content multiplexes are distributed in each local and wide area of the multi-frequency network and provide flow identifiers for overhead flows associated with the content multiplexes, and transmitting the IAFs on pre-assigned flow identifiers.

In an aspect, an apparatus is provided for overhead flow data distribution in a multi-frequency network. The apparatus comprises flow generation logic configured to generate IAFs that describe how content multiplexes are distributed in each local and wide area of the multi-frequency network and provide flow identifiers for overhead flows associated with the content multiplexes, and output logic configured to transmit the IAFs on pre-assigned flow identifiers.

In an aspect, an apparatus is provided for overhead flow data distribution in a multi-frequency network. The apparatus comprises means for generating IAFs that describe how content multiplexes are distributed in each local and wide area of the multi-frequency network and provide flow identifiers for overhead flows associated with the content multiplexes, and means for transmitting the IAFs on pre-assigned flow identifiers.

In an aspect, a computer program product is provided for overhead flow data distribution in a multi-frequency network. The computer program product comprises a machine-readable medium that comprises a first set of codes for causing a computer to generate IAFs that describe how content multiplexes are distributed in each local and wide area of the multi-frequency network and provide flow identifiers for overhead flows associated with the content multiplexes, and a second set of codes for causing the computer to transmit the IAFs on pre-assigned flow identifiers.

In an aspect, at least one integrated circuit is provided that is configured to perform overhead flow data distribution in a multi-frequency network. The at least one integrated circuit comprises a first module configured to generate IAFs that describe how content multiplexes are distributed in each local and wide area of the multi-frequency network and provide flow identifiers for overhead flows associated with the content multiplexes, and a second module configured to transmit the IAFs on pre-assigned flow identifiers.

In an aspect, a method is provided for overhead flow data acquisition in a multi-frequency network. The method comprises receiving IAFs that describe how content multiplexes are distributed in wide and local area of the multi-frequency network, and specify flow identifiers for overhead flows associated with the content multiplexes, wherein the IAFs are received using pre-assigned flow identifiers. The method also comprises processing the IAFs to determine VM sets associated with current wide and local areas of the multi-frequency network, and to determine overhead flow related information associated with selected content multiplexes in the VM sets, and acquiring overhead flow data associated with the selected content multiplexes using the associated flow identifiers.

In an aspect, an apparatus is provided for overhead flow data acquisition in a multi-frequency network. The apparatus comprises receiving logic configured to receive IAFs that describe how content multiplexes are distributed in wide and local areas of the multi-frequency network, and specify flow identifiers for overhead flows associated with the content multiplexes, wherein the IAFs are received using pre-assigned flow identifiers. The apparatus also comprises processing logic configured to process the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

In an aspect, an apparatus is provided for overhead data acquisition in a multi-frequency network. The apparatus comprises means for receiving IAFs that describe how content multiplexes are distributed in wide and local areas of the multi-frequency network, and specify flow identifiers for overhead flows associated with the content multiplexes, wherein the IAFs are received using pre-assigned flow identifiers. The apparatus also comprises means for processing the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

In an aspect, a computer program product is provided for overhead flow data acquisition in a multi-frequency network. The computer program product comprises a machine-readable medium that comprises a first set of codes for causing a computer to receive IAFs that describe how content multiplexes are distributed in wide and local areas of the multi-frequency network, and specify flow identifiers for overhead flows associated with the content multiplexes, wherein the IAFs are received using pre-assigned flow identifiers. The computer program product also comprises a second set of codes for causing the computer to process the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

In an aspect, at least one integrated circuit is provided that is configured to perform overhead flow data acquisition in a multi-frequency network. The at least one integrated circuit comprises a first module configured to receive IAFs that describe how content multiplexes are distributed in wide and local areas of the multi-frequency network, and specify flow identifiers for overhead flows associated with the content multiplexes, wherein the IAFs are received using pre-assigned flow identifiers. The at least one integrated circuit also comprises a second module configured to process the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

Other aspects will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following Description when taken in conjunction with the accompanying drawings wherein:

FIG. 1 shows a network that comprises aspects of an overhead flow data distribution system;

FIG. 2 shows a diagram that illustrates how overhead flows are distributed within a LOI in aspects of an overhead flow data distribution system;

FIG. 3 shows overhead flow logic for use in aspects of an overhead flow data distribution system;

FIG. 4 shows an exemplary area information message that is generated as part of an initial acquisition flow for use in aspects of an overhead flow data distribution system.

FIG. 5 shows an exemplary directory area information message that is generated as part of an initial acquisition flow for use in aspects of an overhead flow data distribution system;

FIG. 6 shows a method for generating overhead flows for use in aspects of a distribution system;

FIG. 7 shows exemplary overhead acquisition logic for use in aspects of an overhead flow data distribution system;

FIG. 8 shows an exemplary method for acquiring overhead flow data for use in aspects of an overhead flow data distribution system;

FIG. 9 shows an exemplary method for processing directory information at a receiving device for use in aspects of an overhead flow data distribution system;

FIG. 10 shows an exemplary method for acquiring primary flow data at a receiving device for use in aspects of an overhead flow data distribution system;

FIG. 11 shows an exemplary method for acquiring overhead flow data at a receiving device for use in aspects of an overhead flow data distribution system;

FIG. 12 shows overhead generation logic for use in aspects of an overhead flow data distribution system; and

FIG. 13 shows overhead acquisition logic for use in aspects of an overhead flow data distribution system.

### DESCRIPTION

In one or more aspects, an overhead flow data distribution system is provided that operates to efficiently distribute overhead flow data over a multi-frequency network. The overhead flow data is transmitted over one or more overhead flows and comprises control and signaling information associated with services or channels being offered as part of the content. For example, the overhead flow data may include programming guide information, list of offered subscription packages, configuration information etc. In an aspect, the overhead flow data distribution system generates an initial acquisition flow that can be easily received at receiving devices in any region of the multi-frequency network. The initial acquisition flow provides information about content multiplexes available in a particular location of the multi-frequency network and flow identifiers used to carry overhead flow data for those multiplexes. Using this information, the device can then proceed to acquire flow data for overhead flows associated with content multiplexes carried in device's current location. The system is well suited for use in wireless network environments, but may be used in any type of network environment, including but not limited to, communication networks, public networks, such as the Internet, private networks, such as virtual private networks (VPN), local area networks, wide area networks, long haul networks, or any other type of data network.

### DEFINITIONS

The following definitions are used herein to describe aspects of an overhead flow data distribution system.
1. Local Area—Refers to a local geographic area such as a building, group of buildings, community, city, county or other local region in which services may be broadcast.
2. Wide Area—Refers to a wide geographic area such as a county, state, multiple states, country, multiple countries or other wide region in which services may be broadcast.
3. Content—Refers to media data e.g. audio, video, text and any other form of media data.
4. Content Multiplex—Refers to a grouping of content flows.
5. Multiplex Set—Refers to a grouping of content multiplexes.
6. Wide Area Multiplex—Refers to a grouping of content flows that are broadcasted over at least one wide area.
7. Local Area Multiplex—Refers to grouping of content flows that are broadcasted over at least one local area.
8. Local Area Operations Infrastructure (LOI)—Refers to a grouping of transmitters and associated systems that operate to transmit content flows over a local area. A LOI maps to the smallest geographical local area which can carry a local area multiplex. A local area multiplex may be broadcasted over one or more LOIs.
9. Wide Area Operations Infrastructure (WOI)—Refers to a grouping of transmitters and associated systems that operate to transmit content flows over a wide area. A WOI maps to the smallest geographical wide area which can carry a wide area multiplex. A WOI comprises of one or more LOIs. A wide area multiplex may be broadcasted over one or more WOIs.
10. RF Channel—Refers to a radio frequency band that is used to convey a content distribution waveform over a selected LOI.
11. Content Channel—Refers to selected content flows within a particular distribution waveform. For example, a distribution waveform may comprise multiple content channels and each content channel may comprise one or more content flows.

### Acronyms

The following acronyms are used herein to describe aspects of an overhead flow data distribution system.

### LM—Local Area Multiplex

### WM—Wide Area Multiplex

### VMS—Vertical Multiplex Set

### UMS—Unified Multiplex Set

### NOC—Network Operations Center

### LOI—Local Operations Infrastructure

### WOI—Wide Operations Infrastructure

### IAF—Initial Acquisition Flow

### GO—Global Overhead

### MSO—Multiplex Specific Overhead

### AIM—Area Identification Message

### DIM—Directory Information Message

### PF—Primary Flow

### Multiplex Sets

In aspects of an overhead flow data distribution system, unique combinations of content multiplexes are defined that form multiplex sets. All the flows belonging to content multiplexes in a multiplex set are associated with that multiplex set. One type of multiplex set is referred to as a vertical multiplex (VM) set. A VM set is defined as a unique combination of content multiplexes carried in a LOI. It is possible for the same VM set to be carried in multiple LOIs or WOIs. VM sets are defined separately for the wide area multiplexes and local area multiplexes that are distributed over each local area of the network 100. In an aspect, a local VM set comprises all local multiplexes distributed over a selected local region (LOI) and a wide VM set comprises all wide multiplexes distributed over a selected wide region (WOI). Each VM set is uniquely identified in the system by a VM set identifier. In an aspect, the VM set identifier space is shared between wide and local VM sets. A new VM set is created for new combinations of content multiplexes carried in wide or local regions when content multiplexes are added, deleted, or updated (in terms of their coverage area).

For each VM set, a list of WOIs or LOIs is maintained which defines the coverage area for that VM set. The coverage area of a VM set identifies the list of geographic regions where the combination of content multiplexes associated with the VM set is carried. For example, for a given wide VM set, the coverage area is defined by the list of WOIs carrying that VM set, and for a given local VM set, the coverage area is defined by the list of LOIs carrying that VM set. Thus, a VM set is modified when coverage area of that VM set is updated due to a change in the coverage area of the associated multiplexes.

In an aspect, another type of multiplex set is defined that is referred to as a unified multiplex (UM) set. UM sets are formed by combining overlapping VM sets until overlapping is eliminated. Two VM Sets are considered to be overlapping if they share at least one common content multiplex. Thus, by definition two different UM Sets never share any common content multiplex. The UM sets are defined separately for wide and local multiplexes. The wide UM sets are formed by combining the overlapping wide VM sets and local UM sets are formed by combining the overlapping local VM sets. All VM sets which are combined to form a given UM set are associated with that UM set.

### Exemplary Aspects

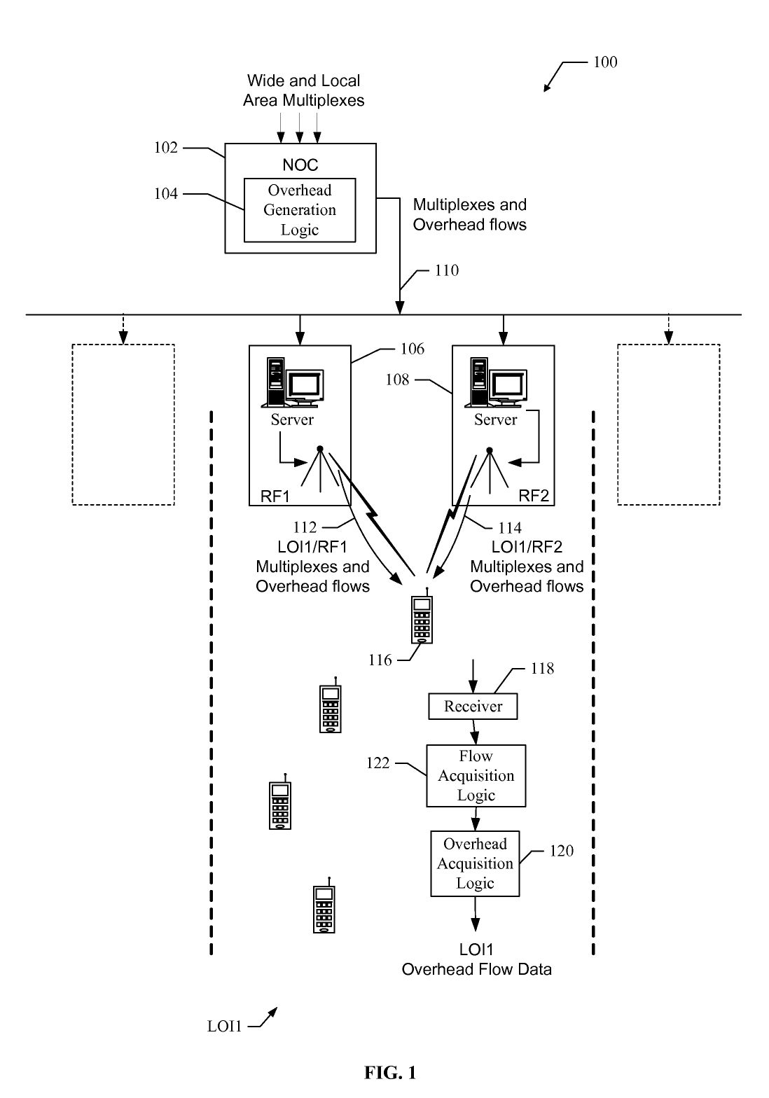

FIG. 1 shows a network 100 that comprises aspects of an overhead flow data distribution system. The network 100 comprises a network operations center (NOC) 102 and a local operations infrastructure (LOI1).

The NOC 102 operates to receive wide and local content multiplexes for distribution over selected WOIs and LOIs of a multi-frequency network. The NOC 102 also operates to configure the multi-frequency network to distribute these content multiplexes and associated overhead information. To accomplish this, the NOC 102 is aware of the geographic regions of the network, the RF channels used in each region, and any other network information that may be needed to configure the network and distribute the wide and local content multiplexes and associated overhead information. In an aspect, the wide and local content multiplexes are identified as part of VM sets and/or UM sets.

In an aspect, the NOC 102 comprises overhead generation logic 104. The overhead generation logic 104 operates to generate overhead flows that are transmitted as part of wide and local area multiplexes over the multi-frequency network 100. The overhead flows carry overhead information applicable to the service layer. The overhead flows are identified with overhead flow IDs. These overhead flow IDs are used by the device to acquire overhead flow data. In an aspect, there are three types of overhead flows generated by the overhead generation logic 104; namely, Multiplex Specific Overhead (MSO) flows, Global Overhead (GO) flows, and Initial Acquisition Flows (IAFs). A MSO flow comprises overhead information which is specific to a given content multiplex. For example, programming guide information may be transmitted as multiplex specific overhead. A GO flow comprises overhead information which is global in nature and is applicable to all content multiplexes. For example, the list of available subscription packages may be transmitted as global overhead. The IAF flows comprise information that describes multiplex sets and associated content multiplexes, distribution of multiplex sets in local and wide regions, and flow IDs associated with overhead flows. In an aspect, the IAF flows comprise an Area Information Message (AIM) and a Directory Information Message (DIM). In an aspect, the IAF flows are sent using pre-assigned flow identifiers. A more detailed description of the IAF flows are provided in another section of this document.

The NOC 102 operates to transmit the content multiplexes and the generated overhead flows to WOIs and LOIs in the network 100. It should be noted that although only one LOI is shown, the NOC 102 may transmit the content multiplexes and generated overhead flows to any number of WOIs and LOIs.

In an aspect, the LOI1 comprise one or more transmitter sites. For example, the LOI1 comprises transmitter sites 106 and 108. Each transmitter site operates to transmit information on a selected RF channel over its respective LOI. For example, the transmitter site 106 transmits information over the LOI1 using the RF channel (RF1), and the transmitter site 108 transmits information over the LOI1 using the RF channel (RF2).

In an aspect, the NOC 102 operates to transmit the content multiplexes and the generated overhead flows to the transmitter sites using any suitable transport mechanism, as illustrated at 110. For example, in an aspect, the NOC 102 transmits the content multiplexes and the generated flows to the transmitter sites using an MPEG-2 transport mechanism. In this configuration, components of the content multiplexes and the generated overhead flows are assigned MPEG-2 transport identifiers so that each transmitter site can detect and receive the appropriate components. For example, different components are assigned different transport identifiers such that a transmitter site can use the transport identifiers to select the appropriate components for distribution over its local region.

The servers at the transmitter sites use the transport identifiers to determine which components are intended for them to transmit over their respective LOIs. The servers then operate to pack their respective content multiplexes and overhead flows into transmission frames for transmission. The servers utilize any suitable physical layer process to pack the content multiplexes and the overhead flows into the transmission frames for transmission.

In an aspect, the transmitter site 106 operates to transmit its transmission frames over the LOI1 using the RF channel (RF1) as shown at 112, and the transmitter site 108 operates to transmit transmission frames over the LOI1 using the RF channel (RF2) as shown at 114. By using multiple RF channels, the network 100 is able to transmit more content multiplexes over the each LOI. It should be noted that the transmitter sites 106 and 108 may be co-located within LOI or separated by any desired distance.

In an aspect, a device 116 comprises a receiver 118 that operates to tune to a selected RF channel in LOI1 to receive selected transmission frames. For example, the receiver 118 operates to tune to the RF channel (RF1) to receive the transmission frames 112 from the transmitter site 106. The transmission frames 112 comprise content multiplexes (wide and/or local multiplexes) designated for distribution over RF1 in LOI1 and associated overhead flows generated by the overhead generation logic 104. The overhead acquisition logic 120 is aware of the flow ID for the IAF flows and operates to request acquisition of the IAF flow data using these pre-assigned flow IDs from flow acquisition logic 122. The flow acquisition logic 122 operates to acquire flow data for overhead and content flows independent of flow types. The flow acquisition logic 122 communicates with the receiver 118 to retrieve information for the IAF flows. The IAF flow provides information related to the multiplex set and associated content multiplexes available in the current LOI for a device. The IAF flow also provides flow IDs for overhead flows associated with content multiplexes carried in current LOI for the device. Using the information received in the IAF, the overhead acquisition logic 120 operates to acquire flow data for global and multiplex specific overhead flows with content multiplexes carried in device's current LOI.

Therefore, aspects of an overhead flow data distribution system operate to efficiently distribute content multiplexes and associated overhead flows over a multi-frequency network. For example, the overhead flow data distribution system generates IAF flows that allow a device to quickly acquire overhead information associated with content multiplexes available in its current location. It should be noted that the network 100 illustrates just one implementation and that other implementations are possible within the scope of the various aspects.

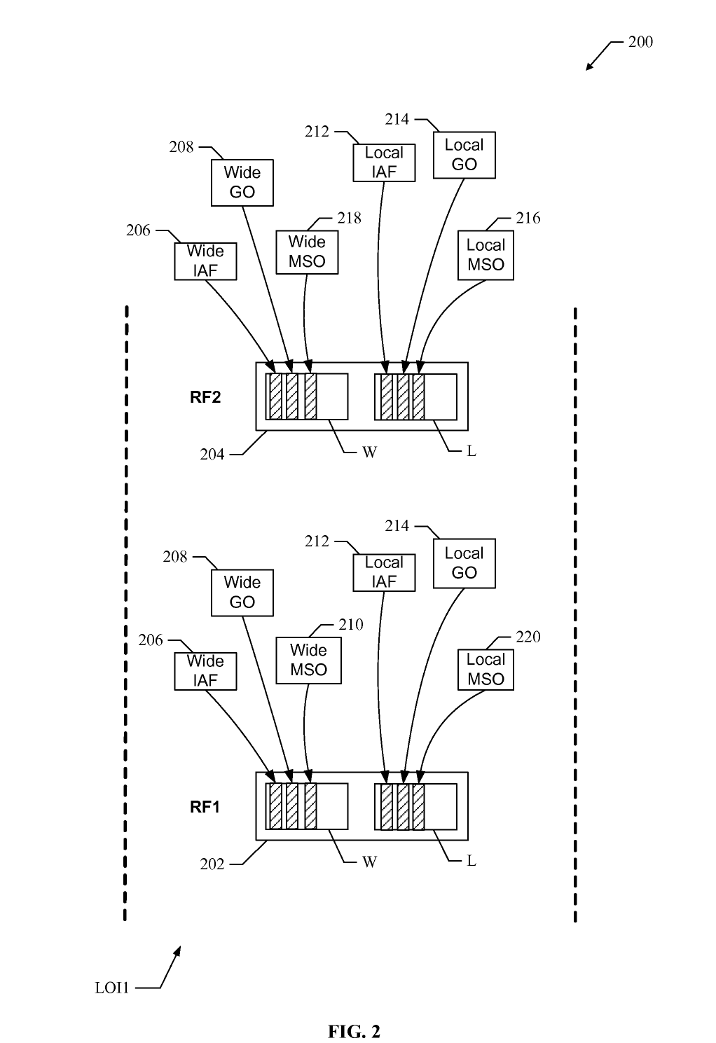

FIG. 2 shows a diagram 200 that illustrates how overhead flows are distributed within a LOI for use in aspects of an overhead flow data distribution system. For example, the transmitter sites 106 and 108 operate to distribute overhead flows within LOI1 utilizing RF channels RF1 and RF2.

The two RF channels (RF1, RF2) are used to transmit transmission frames 202 and 204, respectively. Each transmission frame comprises a wide (W) and a local (L) data partition. In an aspect, a wide IAF 206 is distributed with the wide partition of the transmission frames 202 and 204. A single wide IAF is distributed over both transmission frames 202 and 204. The wide IAF is distributed using a pre-assigned flow ID within the transmission frames 202 and 204 so that devices within the LOI1 will be able to easily receive the IAF from either RF1 or RF2.

The wide partitions of the transmission frames 202 and 204 also carry wide GO flows 208. The same wide GO flows are distributed over both transmission frames 202 and 204. In an aspect the wide GO flows 208 may be distributed over just one transmission frame or a subset of transmission frames in a given LOI to optimize bandwidth utilization. The wide partition of the transmission frame 202 carries wide MSO flows 210. The wide partition of the transmission frame 204 carries different wide MSO flows 218. The local partitions of the transmission frames 202 and 204 carry local IAF 212 and local GO flows 214. The local partitions of the transmission frames 202 and 204 also carry local MSO flows 220 and local MSO flows 216, respectively. A more detailed description of the wide and local IAF, GO flows, and MSO flows are provided in another section of this document.

Thus, the overhead flow data distribution system allows a device to easily receive IAF flows which describe information about the multiplex set and associated content multiplexes available in a particular LOI and overhead flow IDs for these associated content multiplexes. Once this information is known to a receiving device, the device is able to quickly acquire the GO flow data and MSO flow data for content multiplexes available in current LOI.

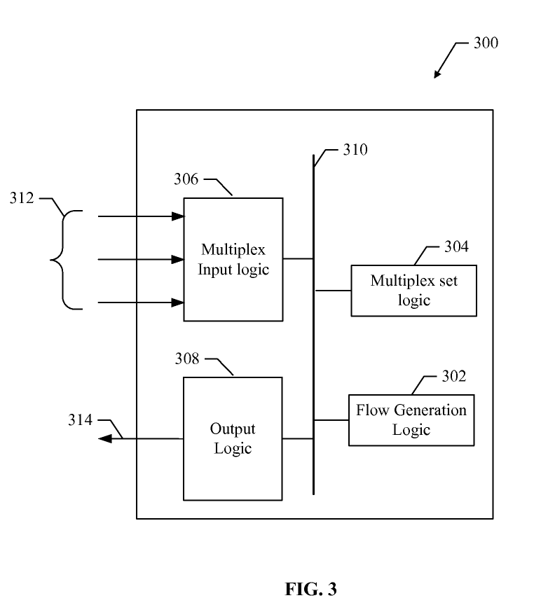

FIG. 3 shows overhead generation logic 300 for use in aspects of an overhead flow data distribution system. For example, the overhead generation logic 300 is suitable for use as the overhead generation logic 104 shown in FIG. 1. The overhead generation logic 300 comprises flow generation logic 302, multiplex set logic 304, multiplex input logic 306, and output logic 308 all coupled to a data bus 310.

The multiplex input logic 306 comprises at least one CPU, processor, gate array, hardware logic, memory elements, and/or hardware executing software. The multiplex input logic 306 operates to receive one or more wide and/or local area content multiplexes 312 that are to be distributed over wide and local regions of a multi-frequency distribution network.

The multiplex set logic 304 comprises at least one CPU, processor, gate array, hardware logic, memory elements, and/or hardware executing software. The multiplex set logic 304 operates to generate one or more multiplex sets for received content multiplexes. In an aspect, a wide area vertical multiplex set comprises all wide area multiplexes that are to be transmitted to a selected LOI, and a local area vertical multiplex set comprises all local area multiplexes that are to be transmitted to a selected LOI. In an aspect, overlapping vertical multiplex sets are combined to form UM sets. Information about the multiplex sets is passed from the multiplex set logic 304 to the flow generation logic 302.

The flow generation logic 302 comprises at least one CPU, processor, gate array, hardware logic, memory elements, and/or hardware executing software. The flow generation logic 302 operates to generate IAF, GO flows, and MSO flows. For example, MSO flows are generated that describe the programming guide information associated with each content multiplex. For example, a GO flow is generated that describes the overall list of available subscription packages. In addition, the flow generation logic 302 operates to generate IAF flows that describe the multiplex set and associated content multiplexes available in a particular LOI and flow IDs for overhead flows associated with these content multiplexes. A more detailed description of the operation of the flow generation logic 302 and the generated overhead flows is provided in other sections of this document.

The output logic 308 comprises at least one CPU, processor, gate array, hardware logic, memory elements, and/or hardware executing software. The output logic 308 operates to output overhead flow data for distribution in LOIs of a multi-frequency network. For example, the output logic 308 operates to output the IAF flows, GO flows, and MSO flows for distribution by the NOC 102 to transmitter sites in a multi-frequency network using any type of transport mechanism. In an aspect, the wide and local IAF flows are transmitted using pre-assigned flow IDs.

In an aspect, the overhead flow data distribution system comprises a computer program product comprising one or more program instructions (“instructions”) or “sets of codes” stored or embodied on a machine-readable medium, which when executed by at least one processor, for instance, a processor at the flow generation logic 302, provides the functions described herein. For example, the sets of codes may be loaded into the overhead generation logic 300 from a machine-readable medium, such as a floppy disk, CDROM, memory card, FLASH memory device, RAM, ROM, or any other type of memory device or machine-readable medium that interfaces to the overhead generation logic 300. In another aspect, the sets of codes may be downloaded into the overhead generation logic 300 from an external device or network resource. The sets of codes, when executed, provide aspects of an overhead flow data distribution system as described herein.

### Initial Acquisition Flow

The initial acquisition flow generated by the flow generation logic 302 comprises overhead information to identify the VM set associated with the current LOI on a device and also includes information for multiplexes associated with the identified VM set. The IAF includes flow IDs for overhead flows (other than IAF flow) transmitted along with content multiplexes. These overhead flow IDs are used by the device to acquire appropriate overhead flow data. The flow generation logic 302 generates flows IDs for overhead flows (other than IAF flows). The flows IDs generated for overhead flows are unique among all overhead flows associated with all content multiplexes in a VM set. This uniqueness criterion for overhead flow IDs generation simplifies acquisition of overhead flow data at the device. Since, each overhead flow is assigned a unique flow ID across content multiplexes in a VM set, a device has no ambiguity when acquiring flow data for any overhead flow. The IAF flow data is generated separately for wide and local multiplexes. In an aspect, the IAF flow data is transmitted over pre-assigned flow IDs. For example, two separate flow IDs are reserved for the wide and local IAF flows, respectively. The IAF data is transmitted over all multiplexes in a VM set. For example, a wide IAF flow is transmitted over all wide multiplexes in a wide VM set, and a local IAF flow is transmitted over all local multiplexes in a local VM set.

The IAF data can be generated either per VM set or for all VM sets associated with a UM set. In an aspect, generating the IAF data per VM set may be efficient with regards to over-the-air (OTA) bandwidth utilization. However, this approach also may result in more infrastructure side complexity as different IAF flows may need to be transmitted along with a content multiplex in different areas depending upon the associated VM set.

In an aspect, generating the IAF data per UM set may be less efficient from an OTA bandwidth perspective since content multiplexes in each VM set carry IAF data for all other content multiplexes associated with other VM sets in the UM set, and a device may only use information for current VM set. However, this approach may result in simpler infrastructure side design as the same IAF is transmitted along with a content multiplex in all areas where that multiplex is carried.

In an aspect, the IAF data comprises an area identification message that contains area information for VM sets to identify the VM set carried in the current LOI for the device. Two separate AIM messages are generated for wide and local IAF flows. The IAF data also comprises a directory information message that contains content multiplex related information for one or more VM sets. Two separate DIM messages are generated for wide and local IAF flows. The AIM and DIM messages are described in further detail below.

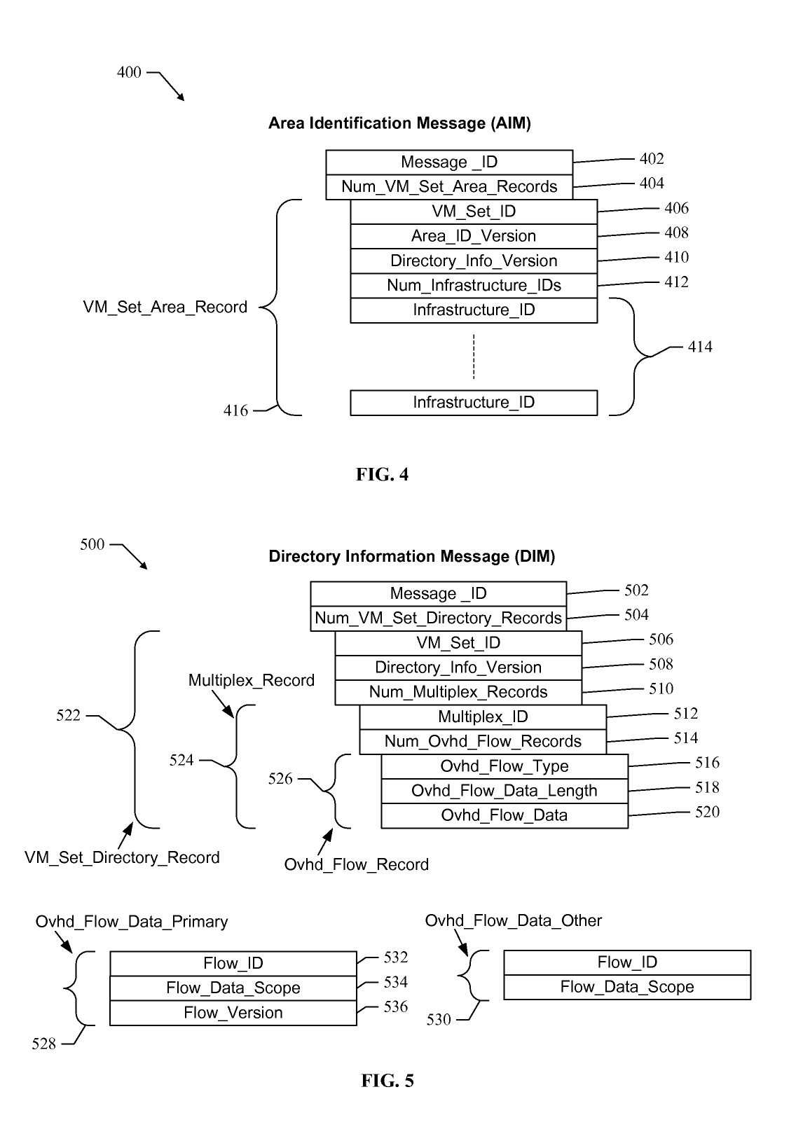

FIG. 4 shows an exemplary area identification message 400 that is generated as part of IAF data for use in aspects of an overhead flow data distribution system. For example, in an aspect, the AIM 400 is generated by the flow generation logic 302. The AIM 400 includes area information per VM set or per UM set (for all VM sets in a UM set). The AIM 400 comprises a VM set record for each VM set and will include only one VM set record if the AIM is generated using ‘per VM set’ mode or if a UM set contains only one VM set (for ‘per UM set’ mode). If the AIM 400 is generated ‘per UM set’ and the UM set has more than one VM set, the AIM 400 will include multiple VM set records, one for each VM set associated with the UM Set.

The AIM 400 comprises a message identifier 402 that identifies the message as an AIM message. The AIM 400 also comprises a (Num_VM_Set_Area_Records) parameter 404 that indicates the total number of instances of VM set area record 416 included in the AIM 400. In general, each VM set record will specify coverage area for that VM set. A VM set record is versioned to accommodate changes in coverage area for that VM set. A wide VM set record specifies coverage area in terms of a list of WOIs. A local VM set record specifies coverage area in terms of a list of LOIs. However, the AIM 400 can be optimized if it contains only a single VM set record. This can happen for two cases described above and in these cases the VM set record will not include any coverage area. A receiving device will use coverage area information within a VM set record to determine the current VM set (associated with current WOI/LOI). If only a single VM set record is included, that VM set record is considered as the current VM set by a receiving device.

Each of the VM set area records 416 comprises a VM set identifier (VM_Set_ID) 406 that identifies a particular VM set. The record 416 also comprise an area identifier version (Area_ID_Version) parameter 408 that identifies a particular version of the list of infrastructure identifiers 414 associated with the record 416. The area identifier version (Area_ID_Version) parameter 408 will be updated as the associated list of infrastructure identifiers 414 changes. A directory information version (Directory_Info_Version) parameter 410 is provided that identifies the version of directory information associated with the VM Set. The directory information is captured in the directory information message described below. The records 416 also comprise number of infrastructure identifiers (Num_Infrastructure_IDs) parameter 412 that indicates the total number of infrastructures identified by infrastructure identifier (Infrastructure_ID) parameters 414.

FIG. 5 shows an exemplary directory information message 500 that is generated as part of an IAF for use in aspects of an overhead flow data distribution system. For example, the DIM 500 is generated by the flow generation logic 302. The DIM 500 provides list of content multiplexes and associated overhead flow information for one or more VM sets. The DIM includes multiplex information for all the VM sets included in the AIM. In an aspect, the DIM is generated per VM set if the AIM generated using that mode. The DIM is generated per UM set if the AIM generated using that mode. The DIM comprises a directory record for each VM set. Each directory record is versioned separately and includes list of content multiplexes in the associated VM set. For each content multiplex, an overhead flow type to flow ID mapping is provided. The DIM includes flow information for all overhead flows defined in the system. One type of overhead flow is called primary flow (PF) which contains version information for all other overhead flows. The device uses the primary flow to determine updates to other overhead flows in the system. For the primary flow, the DIM also includes a primary flow version. Thus, a receiving device can detect changes to the primary flow by monitoring a received DIM message.

The DIM 500 comprises a message identifier 502 that identifies the message as a DIM message. The DIM 500 also comprises a (Num_VM_Set_Dierctory_Records) parameter 504 that indicates how many instances of VM set directory record 522 are provided in the DIM 500.

Each instance of a VM set directory record 522 comprises a VM set identifier (VM_Set_ID) parameter 506 that identifies a VM set. The VM_Set_ID included in the DIM message is the same as the corresponding VM_Set_ID in the AIM message. A directory information version (Directory_Info_Version) parameter 508 is also provided that identifies a directory version. The Directory_Info_Version included in the DIM message for a particular VM set is the same as the corresponding Directory_Info_Version in the AIM message for that VM set. The VM set directory record 522 also comprises a number of multiplex records (Num_Multiplex_Records) parameter 510 that indicates how many instances of multiplex record 524 are provided in the DIM 500.

Each instance of a multiplex record 524 comprises a multiplex identifier (Multiplex_ID) parameter 512 that identifies a content multiplex. The multiplex record 524 also comprises a number of overhead flow records (Num_Ovhd_Flow_Records) parameter 514 that indicates how many instances of overhead flow records 526 are provided in the DIM 500.

Each instance of an overhead flow record 526 comprises an overhead flow type (Ovhd_Flow_Type) parameter 516 that identifies a type for the overhead flow. The overhead flow record 526 also comprises an overhead flow data length (Ovhd_Flow_Data_Length) parameter 518 that indicates the size of overhead flow data (Ovhd_Flow_Data) record 520 to follow.

The overhead flow data record 520 can be either a primary overhead flow data record 528 (Ovhd_Flow_Data_Primary) or other overhead flow data record 530 (Ovhd_Flow_Data_Other). Each type of data record comprises a flow identifier (Flow_ID) parameter 532 that identifies an overhead flow, and a flow data scope (Flow_Data_Scope) parameter 534 that identifies an overhead flow data scope (global or multiplex specific). In an aspect, the flow data scope can be used to optimize reception for global overhead flows. Global overhead flows can be acquired only from one of the multiplexes in a device's current VM set. In addition, primary overhead flow data record 528 comprises a flow version (Flow Version) parameter 536 which identifies a version of the primary flow.

In an aspect, the flow generation logic 302 generates and persistently maintains a separate Area_ID_Version for each VM set. The Area_ID_Version provides the current state of the coverage area (i.e., the set of WOIs/LOIs) for a given VM set. Whenever updates to the coverage area are received for a VM set, the flow generation logic 302 increments the Area_ID_Version for that VM set. In addition, the flow generation logic 302 also updates the coverage area in the AIM message accordingly. Whenever the AIM is updated, flow generation logic 302 sends updated AIM and DIM messages to the associated LOIs in the multi-frequency network. In an aspect, flow generation logic 302 generates and persistently maintains a separate Directory_Info_Version for each VM set. The Directory_Info_Version provides the current state of the directory information associated with a Directory record for a given VM set. In an aspect, the flow generation logic 302 increments the Directory_Info_Version for a VM set based on at least one of the following.
a. Flow Version for the primary flow is updated for at least one of the multiplexes in the VM set.
b. Overhead flow type to flow ID mapping is updated.
c. Overhead flow data scope is updated for an overhead flow, for example, if a global overhead flow is made multiplex specific.
d. New overhead flow types get defined to support a new feature.

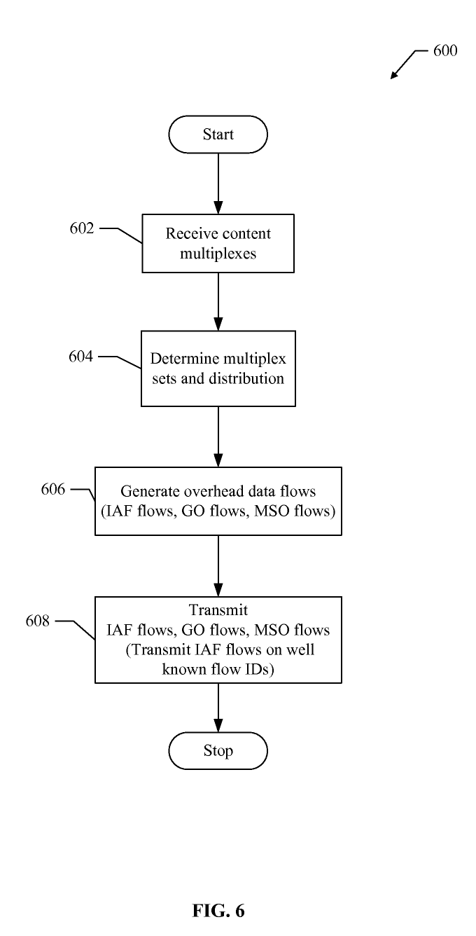

FIG. 6 shows a method 600 for generating overhead data flows for use in aspects of an overhead flow data distribution system. For clarity, the method 600 is described herein with reference to the overhead generation logic 300 shown in FIG. 3. For example, in an aspect, the flow generation logic 302 executes one or more sets of codes to control the overhead generation logic 300 to perform the functions described below.

At block 602, one or more wide and/or local multiplexes are received for distribution over a multi-frequency network. For example, the multiplexes are received at the multiplex input logic 306.

At block 604, the received multiplexes are processed to generate multiplex sets based on the distribution of content multiplexes. The network distribution of these multiplex sets is also determined. For example, the multiplex set logic 304 operates to generate multiplex sets and determine the distribution of these multiplex sets to selected WOIs and LOIs of a multi-frequency network.

At block 606, overhead flows are generated based on the multiplex sets and their respective distribution over the multi-frequency network. For example, the flow generation logic 302 operates to generate IAF flows, GO flows and MSO flows associated with the received multiplexes. The IAF flows are generated based on the multiplex sets and their respective distribution over the multi-frequency network. In an aspect, the IAF flows comprise parameters that are formatted as illustrated in FIG. 4 and FIG. 5.

At block 608, the multiplexes and their associated flows are distributed along with content multiplexes over a multi-frequency network. In an aspect, IAF flows are distributed over pre-assigned flow IDs so that receiving devices can receive the IAF flows before receiving any other overhead information. This allows the device to acquire overhead information quickly thereby providing fast access to multiplexes transmitted in the new LOI. In an aspect, multiplexes and their associated overhead flows are output by the output logic 308 for transport from the NOC 102 to the transmitter sites using any suitable transport mechanism.

Thus, the method 600 operates to provide aspects of an overhead flow data distribution system. It should be noted that the method 600 represents just one implementation and that other implementations are possible within the scope of the aspects.

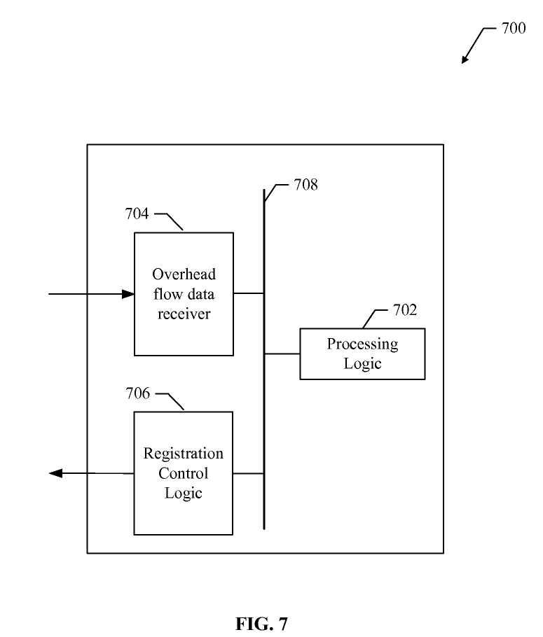

FIG. 7 shows exemplary overhead acquisition logic 700 for use in aspects of a flow data distribution system. For example, the overhead acquisition logic 700 is suitable for use as the overhead acquisition logic 120 shown in FIG. 1. The overhead acquisition logic 700 comprises processing logic 702, overhead flow data receiver 704, and registration control logic 706, all coupled to a data bus 708.

The overhead flow data receiver 704 comprises at least one of a CPU, processor, gate array, hardware logic, memory elements, and/or hardware executing software. The overhead flow data receiver 704 operates to receive IAF flow data over pre-assigned flow IDs. The overhead flow data receiver 704 receives the AIM and DIM messages as part of the IAF flow.

The processing logic 702 comprises at least one of a CPU, processor, gate array, hardware logic, memory elements, and/or hardware executing software. In an aspect, the processing logic 702 operates to process received IAF data to determine information about content multiplexes available in a particular LOI. The processing logic 702 also operates to acquire and process other types of overhead flow data.

The registration control logic 706 comprises at least one of a CPU, processor, gate array, hardware logic, memory elements, and/or hardware executing software. The registration control logic 706 operates to provide a mechanism to register and deregister overhead flows with lower layer flow acquisition logic to acquire overhead flow data. For example, the registration control logic 706 interfaces with the flow acquisition logic 122 shown in FIG. 1 to register and deregister overhead flows.

In an aspect, the overhead flow data distribution system comprises a computer program product having one or more program instructions (“instructions”) or sets of “codes” stored on a machine-readable medium, which when executed by at least one processor, for instance, a processor at the processing logic 702, provide the functions described herein. For example, the sets of codes may be loaded into the overhead acquisition logic 700 from a machine-readable medium, such as a floppy disk, CDROM, memory card, FLASH memory device, RAM, ROM, or any other type of memory device or machine-readable medium that interfaces to the overhead acquisition logic 700. In another aspect, the sets of codes may be downloaded into the overhead acquisition logic 700 from an external device or network resource. The sets of codes, when executed, provide aspects of a selection system as described herein.

### Overhead Flow Data Acquisition

In an aspect, the overhead acquisition logic 700 operates to periodically (or at selected times) monitor the IAF flows (wide and local IAF) to detect any updates to overhead flow data. In an aspect, a registration mechanism is provided at a device by the lower layer flow acquisition logic 122 to register flows for acquiring flow data. To acquire IAF flow data, the registration control logic 706 registers pre-assigned overhead flow identifiers associated with IAF flows with the flow acquisition logic 122. The flow acquisition logic 122 acquires data for registered overhead flows based on any suitable priority mechanism. The IAF flows are carried on all multiplexes in a VM set. In response to IAF registration, the flow acquisition logic 122 will communicate with receiver 118 to acquire IAF data from current RF and provide it to the overhead flow data receiver 704.

In an aspect, at every device power-up or periodic IAF monitoring time, the processing logic 702 attempts to acquire both wide and local overhead flow data. The processing logic 702 initiates both wide and local IAF acquisitions at power-up and at periodic monitoring intervals. Based on IAF data received, the processing logic 702 acquires wide and/or local primary flows (if needed). Updates to the primary flow versions included in the IAF initiates acquisition of primary flows. The primary flow contains version information for data associated with other overhead flows. Based on updates to version data in the primary flow, the processing logic 702 acquires other wide and local overhead flows (if needed). The processing logic 702 interfaces with the registration control logic 706 to register IAF flows, primary flows and other overhead flows for overhead data acquisition. The flow IDs received for primary flows and other overhead flows in the IAF are used to register primary flows and other overhead flows respectively for overhead data acquisition. Wide and local overhead flow data acquisitions are independent of each other in terms of data being acquired.

### Power-Up Overhead Data Acquisition

In an aspect, the processing logic 702 performs power-up overhead data acquisition by performing one or more of the following operations at device power-up.
Register pre-assigned IAF flow IDs to acquire IAF data.
Receive IAF flow data from the flow acquisition logic 122.
Acquire AIM and DIM messages from IAF data.
Use AIM and current infrastructure identifier to determine current VM set.
Store latest overhead flow information from DIM associated with current VM set.
Register to receive primary flow data for multiplexes in current VM set. Use flow IDs received in the DIM for primary flows associated with these multiplexes for the registration.
Receive primary flow data from the flow acquisition logic 122.
From primary flow data determine if other overhead flows are updated.
Register to receive data for any other updated overhead flows. Use flow IDs received in the DIM for other updated overhead flows for the registration.
Receive other updated overhead flow data from the flow acquisition logic 122.
Process other overhead flow data.

### Periodic Overhead Data Acquisition

In an aspect, the processing logic 702 performs periodic overhead data acquisition by periodically performing one or more of the following operations.
Register pre-assigned IAF flow IDs to acquire IAF data.
Receive IAF flow data from the flow acquisition logic 122.
Acquire AIM and DIM messages from IAF data.
If the Area_ID_Version parameter has changed for the device's current VM set, determine a new current VM set based on updated AIM.
If the Directory_Info_Version parameter has changed for the device's current VM set, store latest overhead flow information from DIM.
Use primary flow version in DIM to determine if the primary flow data has changed for multiplexes in the current VM set.
Register to receive updated primary flow data (if any). Use flow IDs received in the DIM for updated primary flows for the registration.
Receive primary flow data from the flow acquisition logic 122.
From primary flow data determine if other overhead flows are updated.
Register to receive data for any other updated overhead flows. Use flow IDs received in the DIM for other updated overhead flows for the registration.
Receive updated overhead flow data from the flow acquisition logic 122.
Process updated overhead flow data.

### Parameters Maintained at Device

In an aspect, the processing logic 702 maintains one or more of the following parameters at the device.
Current VM set identifiers (wide VM set associated with current WOI and local VM set associate with current LOI).
Area_ID_Version for current VM sets.
Directory_Info_Version for current VM sets.
Directory information data for all multiplexes in current VM sets. This includes flow type to flow identifier mapping and flow data scope for overhead flows.
Primary flow version for each multiplex in current VM sets.
Overhead flow data versioning information included in primary flow for each multiplex in current VM sets.

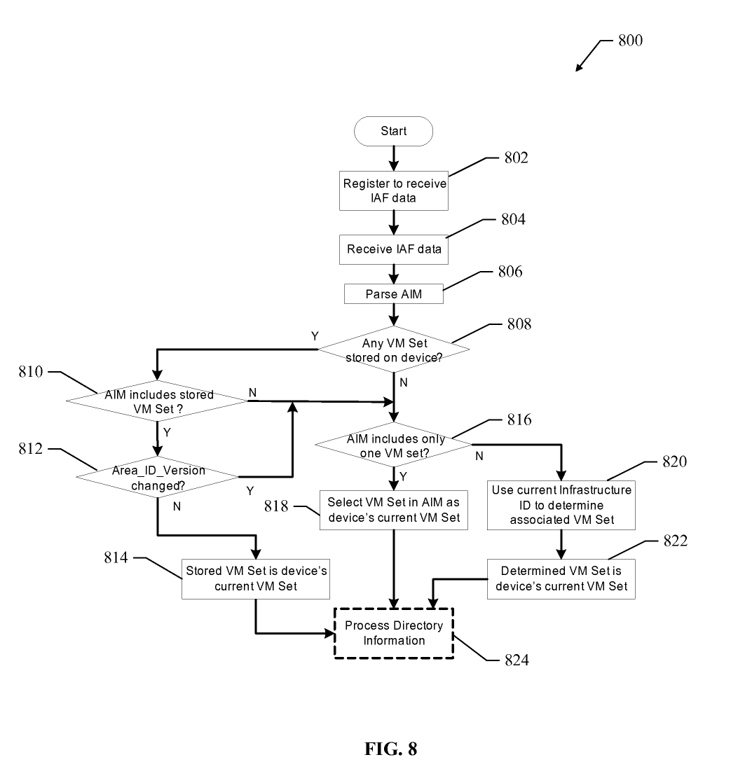

FIG. 8 shows an exemplary method 800 for acquiring overhead flow data for use in aspects of an overhead flow data distribution system. For clarity, the method 800 is described herein with reference to the overhead acquisition logic 700 shown in FIG. 7. For example, in an aspect, the processing logic 702 executes one or more sets of codes to control the overhead acquisition logic 700 to perform the functions of the method 800 described below. In an aspect, the method 800 is executed separately for wide and local multiplexes to acquire wide and local overhead flow data.

At block 802, a registration to receive IAF data is performed. For example, the registration control logic 706 registers with the flow acquisition logic 122 to receive the IAF data. The registration control logic 706 will register wide IAF and local IAF to initiate acquisition for wide overhead flows and local overhead flows respectively. The registration control logic 706 uses pre-assigned flow IDs to register IAF flows.

At block 804, IAF data is received from the flow acquisition logic 122. In an aspect, the IAF data is received by the overhead flow data receiver 704 from the flow acquisition logic 122. The IAF data is then passed to the processing logic 702.

At block 806, the AIM message received as part of the IAF is parsed. For example, the IAF data comprises AIM and DIM messages, which are formatted as illustrated in FIG. 4 and FIG. 5. In an aspect, the processing logic 702 parses the received AIM and DIM messages to determine overhead flow related information for content multiplexes distributed in the current LOI.

At block 808, a determination is made as to whether any VM set data is currently stored at the device. In an aspect, the processing logic 702 operates to store VM set data from previously received IAF data at the device. The processing logic 702 determines if there is any previously stored VM set data at the device. If there is VM set data currently stored at the device, the method proceeds to block 810. If there is no VM set data currently stored at the device (e.g. in power-up overhead data acquisition case) the method proceeds to block 816.

At block 810, a determination is made as to whether the newly received AIM includes the stored VM set data. In an aspect, the processing logic 702 operates to compare VM set data stored at the device with VM set data received in the AIM to make this determination. If the received AIM includes stored VM set data, the method proceeds to block 812. If the received AIM does not include the stored VM set data, the method proceeds to block 816.

At block 812, a determination is made as to whether the Area_ID_Version parameter for the stored VM set has changed. In an aspect, the Area_ID_Version parameter associated with the stored VM set is parsed from the received AIM by the processing logic 702 and compared to the stored value of this parameter. If the Area_ID_Version parameter has not changed, the method proceeds to block 814. If the Area_ID_Version parameter has changed, the method proceeds to block 816.

At block 814, the stored VM set is determined to be the device's current VM set. In an aspect, the processing logic 702 makes this determination and sets appropriate indicators at the device to indicate this state.

At block 816, a determination is made as to whether the received AIM includes only one VM set. In an aspect, the processing logic 702 operates to parse the received AIM to determine whether it contains parameters relating to only one VM set. If the received AIM includes only one VM set, the method proceeds to block 818. If the received AIM contains more than one VM set, the method proceeds to block 820.

At block 820, the current infrastructure identity (WOI or LOI) is used to determine the VM set associated with current area. In an aspect, the processing logic 702 determines current VM set from the received AIM based on the current infrastructure identity. For example, the processing logic 702 will use current WOI to determine current wide VM set and will use the current LOI to determine the current local VM set.

At block 822, the device's current VM set is set to the determined VM set. In an aspect, the processing logic 702 operates to set the appropriate indicators at the device to set the device's current VM set to the determined VM set.

At block 818, the single VM set received in the AIM message is selected as the device's current VM set. In an aspect, the processing logic 702 operates to set the appropriate indicators at the device to set the device's current VM set to the single VM set received in the AIM message.

At block 824, directory information included in the received DIM is processed. For clarity, the operations included in block 824 are illustrated and described in method 900.

Thus, the method 800 operates to provide aspects of an overhead flow data distribution system. In an aspect, the method 800 is executed separately for wide and local multiplexes to acquire wide and local overhead flow data. It should be noted that the method 800 represents just one implementation and that other implementations are possible within the scope of the aspects.

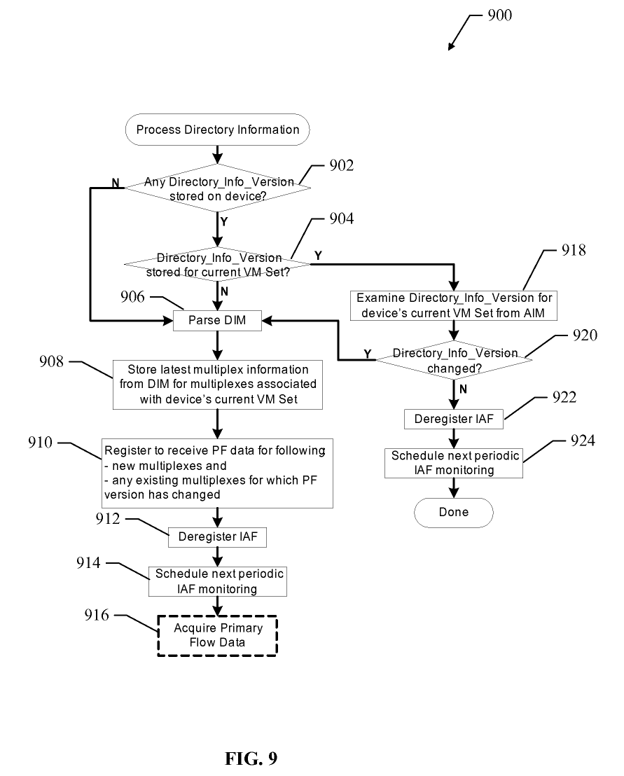

FIG. 9 shows an exemplary method 900 for processing directory information at a receiving device for use in aspects of an overhead flow data distribution system. For example, the method 900 is suitable for use at block 824 of the method 800. For clarity, the method 900 is described herein with reference to the overhead acquisition logic 700 shown in FIG. 7. For example, in an aspect, the processing logic 702 executes one or more sets of codes to control the overhead acquisition logic 700 to perform the functions of the method 900 described below. The method 900 is executed separately for wide and local multiplexes to process associated wide and local directory information.

At block 902, a determination is made as to whether any Directory_Info_Version data is stored at the device. In an aspect, the processing logic 702 makes this determination based on information that is locally stored. If there is Directory_Info_Version data stored at the device, the method proceeds to block 904. If there is no Directory_Info_Version data stored at the device (e.g. in power-up overhead data acquisition case), the method proceeds to block 906.

At block 904, a determination is made as to whether there is Directory_Info_Version data stored at the device for the device's current VM set. The device's current VM set is determined as per the logic captured in the method 800. In an aspect, the processing logic 702 determines if Directory_Info_Version data is stored for current VM set based on information that is locally stored. If there is Directory_Info_Version data stored at the device for the current VM set, the method proceeds to block 918. If there is no Directory_Info_Version data stored at the device for the current VM set, the method proceeds to block 906. For example, if the device moves to a new LOI carrying a new VM set, the Directory_Info_Version data for the current VM set will not be stored at the device.

At block 906, a DIM message received as part of the IAF data is parsed. In an aspect, the processing logic 702 operates to parse the DIM message to determine relevant parameters.

At block 908, the latest multiplex information from the DIM for multiplexes associated with the device's current VM set is stored. In an aspect, the processing logic 702 operates to determine this information from the DIM and store it locally at the device.

At block 910, registrations are performed to receive primary flow data for any new multiplexes in current VM set for which the device does not already have stored information and any existing multiplexes in current VM set for which the primary flow version has changed. The flow IDs received in the DIM for primary flows associated with these multiplexes are used for the registration. In an aspect, the registration control logic 706 operates to register with the flow acquisition logic 122 to receive the primary flow information.

At block 912, the IAF flow is deregistered with the flow acquisition logic 122. In an aspect, the registration control logic 706 operates to perform this deregistration.

At block 914, the next periodic IAF monitoring event is scheduled. For example, the processing logic 702 schedules a time at which the IAF data will be received and monitored next.

At block 916, the appropriate primary flow data is acquired. For clarity, the operations included in block 916 are illustrated and described in method 1000.

At block 918, the Directory_Info_Version parameter for the device's current VM set provided in the AIM message is examined. In an aspect, the processing logic 702 performs this operation.

At block 920, a determination is made as to whether the Directory_Info_Version parameter for device's current VM set has changed. In an aspect, the processing logic 702 makes this determination by comparing this parameter received in the AIM with the locally stored value for the Directory_Info_Version parameter for the device's current VM set. If the Directory_Info_Version parameter has changed, the method proceeds to block 906 and parses the received DIM message. If the Directory_Info_Version parameter has not changed, the method proceeds to block 922.

At block 922, the IAF flow is deregistered with the flow acquisition logic 122. In an aspect, the registration control logic 706 operates to perform this deregistration.

At block 924, the next periodic IAF monitoring event is scheduled. For example, the processing logic 702 schedules a time at which the IAF data will be received and monitored next. After block 924, the method 900 ends.

Thus, the method 900 operates to provide aspects of an overhead flow data distribution system. It should be noted that the method 900 represents just one implementation and that other implementations are possible within the scope of the aspects.

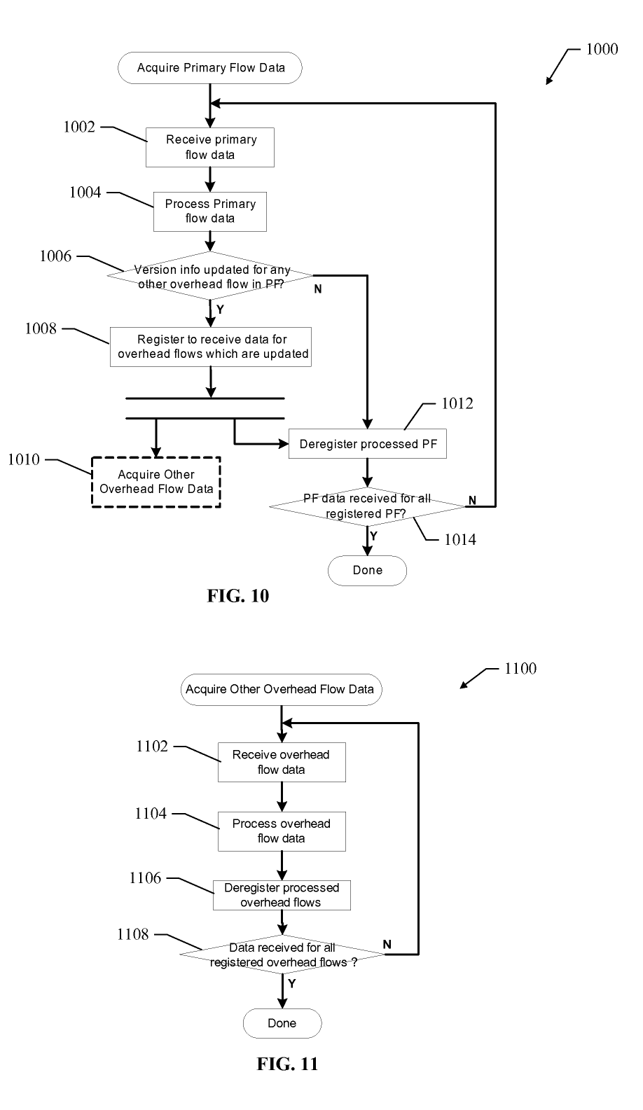

FIG. 10 shows an exemplary method 1000 for acquiring primary flow data at a receiving device for use in aspects of an overhead flow data distribution system. For example, the method 1000 is suitable for use at block 916 of the method 900. For clarity, the method 1000 is described herein with reference to the acquisition logic 700 shown in FIG. 7. For example, in an aspect, the processing logic 702 executes one or more sets of codes to control the acquisition logic 700 to perform the functions of the method 1000 described below.

At block 1002, primary flow data is received from the flow acquisition logic 122. In an aspect, the primary flow data is received by the overhead flow data receiver 704 and passed to the processing logic 702.

At block 1004, processing of the primary flow data is performed by the processing logic 702.

At block 1006, a determination is made as to whether version information for overhead flows included in the primary flow has been updated for one or more overhead flows. In an aspect, the processing logic 702 makes this determination by comparing version information received in the primary flow with associated version information locally stored on the device. If version information has not been updated, the method proceeds to block 1012. If version information has been updated, the method proceeds to block 1008.

At block 1008, registrations are performed to receive data for overhead flows for which version information has been updated. The flow IDs received in the DIM for these updated overhead flows are used for the registration. In an aspect, the registration control logic 706 operates to perform registrations with the flow acquisition logic 122 to receive this data.

It should be noted that operations at blocks 1010 and 1012 proceed in a parallel fashion.

At block 1010, overhead flow data is acquired for overhead flows registered in block 1008. In an aspect, the overhead flow data receiver 704 receives overhead flow data for registered flows from the flow acquisition logic 122.

At block 1012, the primary flow which has already been processed in steps 1006 and 1008 is deregistered. In an aspect, the registration control logic 706 operates to deregister the already processed primary flow from the flow acquisition logic 122.

At block 1014, a determination is made as to whether primary flow data for all registered primary flows has been received. In an aspect, the processing logic 702 makes this determination based on the primary flow data that has been received. If primary flow data for all registered primary flows has not been received, the method 1000 proceeds to block 1002. If primary flow data for all registered primary flows has been received the method 1000 ends.

Thus, the method 1000 operates to provide aspects of an overhead flow data distribution system. It should be noted that the method 1000 represents just one implementation and that other implementations are possible within the scope of the aspects.

FIG. 11 shows an exemplary method 1100 for acquiring other overhead flow data (other than the primary flow) at a receiving device for use in aspects of an overhead flow data distribution system. For example, the method 1100 is suitable for use at block 1010 of the method 1000. For clarity, the method 1100 is described herein with reference to the acquisition logic 700 shown in FIG. 7. For example, in an aspect, the processing logic 702 executes one or more sets of codes to control the acquisition logic 700 to perform the functions of the method 1100 described below.

At block 1102, overhead flow data is received from the flow acquisition logic 122. In an aspect, the overhead flow data receiver 704 operates to receive overhead flow data from the flow acquisition logic 122.

At block 1104, the received overhead flow data is processed. In an aspect, the overhead flow data is processed by the processing logic 702.

At block 1106, overhead flows which have been already received and processed are deregistered. In an aspect, the registration control logic 706 operates to deregister these overhead flows.

At block 1108, a determination is made as to whether overhead data has been received for all registered overhead flows registered during step 1008. In an aspect, the processing logic 702 makes this determination. If all overhead data has not been received, the method 1100 proceeds to block 1102. If all overhead data has been received, the method 1100 ends.

Thus, the method 1100 operates to provide aspects of an overhead flow data distribution system. It should be noted that the method 1100 represents just one implementation and that other implementations are possible within the scope of the aspects.

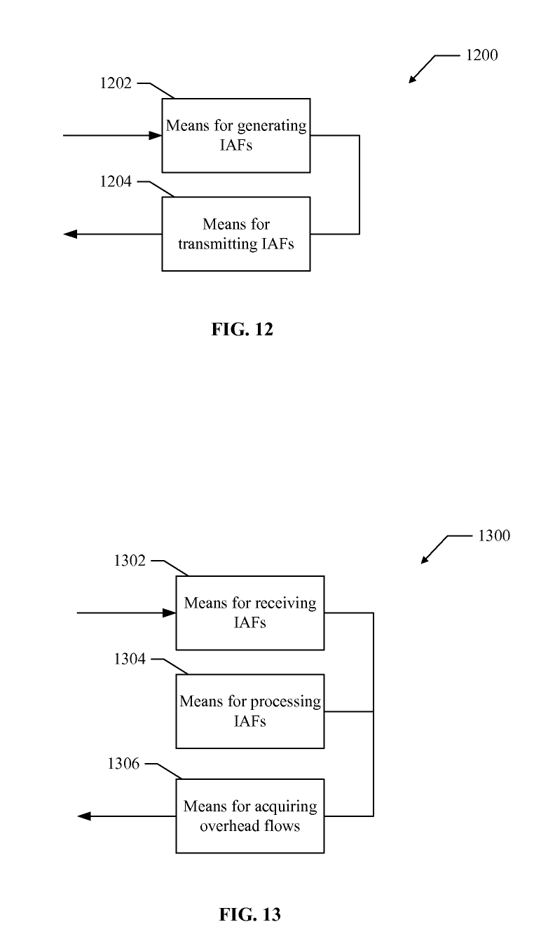

FIG. 12 shows overhead generation logic 1200 for use in aspects of a distribution system. For example, the overhead generation logic 1200 is suitable for use as the overhead generation logic 300 shown in FIG. 3. In an aspect, the overhead generation logic 1200 is implemented by one or more modules comprising at least one processor configured to provide aspects of an overhead flow data distribution system as described herein. For example, in an aspect, each module comprises hardware and/or hardware executing software.

The overhead generation logic 1200 comprises a first module comprising means (1202), for generating initial acquisition flows (IAFs) that describe how content multiplexes are distributed in each local and wide area of the multi-frequency network and provide flow identifiers for overhead flows associated with the content multiplexes, which in an aspect comprises the flow generation logic 302. The overhead generation logic 1200 also comprises a second module comprising means (1204) for transmitting the IAFs on pre-assigned flow identifiers, which in an aspect comprises the output logic 308.

FIG. 13 shows overhead acquisition logic 1300 for use in aspects of an overhead flow data distribution system. For example, the overhead acquisition logic 1300 is suitable for use as the overhead acquisition logic 700 shown in FIG. 7. In an aspect, the overhead acquisition logic 1300 is implemented by one or more modules comprising at least one processor configured to provide aspects of an overhead flow data distribution system as described herein. For example, in an aspect, each module comprises hardware and/or hardware executing software.

The overhead acquisition logic 1300 comprises a first module comprising means (1302) for receiving initial acquisition flows (IAFs) that describe how content multiplexes are distributed in local and wide areas of the multi-frequency network and specify flow identifiers for overhead flows associated with the content multiplexes, wherein the IAFs are received on pre-assigned flow identifiers, which in an aspect comprises the overhead flow data receiver 704. The overhead acquisition logic 1300 also comprises a second module comprising means (1304) for processing the IAFs to determine VM sets associated with current wide and local areas of the multi-frequency network, and to determine overhead flow related information associated with selected content multiplexes in the VM sets. The overhead acquisition logic 1300 also comprises a third module comprising means (1306) for acquiring overhead flow data associated with the selected content multiplexes using the associated flow identifiers, which in an aspect comprises the processing logic 702.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of an overhead flow data distribution system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for overhead flow data distribution in a multi-frequency network, the method comprising:
generating initial acquisition flows (IAFs) that describe how content multiplexes are distributed in each local and wide area of the multi-frequency network and provide flow identifiers for overhead flows associated with the content multiplexes; and
transmitting the IAFs on pre-assigned flow identifiers.

2. The method of claim 1, wherein said generating comprises generating separate IAF flows for wide and local content multiplexes, respectively.

3. The method of claim 1, wherein said generating comprises generating a selected IAF flow for each VM set, wherein the selected IAF flow includes information for content multiplexes in the associated VM set.

4. The method of claim 1, wherein said generating comprises generating a selected IAF flow for all VM sets in each UM set, wherein the selected IAF flow includes information for content multiplexes associated with all VM sets in the associated UM set.

5. The method of claim 1, wherein said generating comprises generating each IAF flow to comprise a separate area identification message (AIM) and a separate directory information message (DIM).

6. The method of claim 5, wherein said generating comprises generating each AIM to comprise area information describing a coverage area for each VM set for which the associated IAF flow is generated.

7. The method of claim 6, wherein said generating comprises optimizing AIM to omit the area information if the AIM includes only one VM set.

8. The method of claim 6, wherein said generating comprises generating each AIM to include an area version parameter associated with the area information and a directory version parameter associated with directory information for each associated VM set.

9. The method of claim 8, wherein said generating comprises generating an updated AIM to update the area version parameter and the area information for each associated VM set if a coverage area for any associated VM set is changed.

10. The method of claim 8, wherein said generating comprises generating an updated AIM to include an updated directory version parameter if the directory information for any associated VM set is changed.

11. The method of claim 5, wherein said generating comprises generating each DIM to comprise directory information which includes a list of content multiplexes and their overhead flow related information for each VM set included in the AIM carried on associated IAF.

12. The method of claim 11, wherein said generating comprises generating each DIM to include an overhead flow type to flow identifier mapping and an overhead flow data scope parameter for overhead flows associated with each content multiplex in each VM set.

13. The method of claim 12, wherein said generating comprises generating each DIM to include a flow version parameter for a primary flow associated with each content multiplex in each VM set.

14. The method of claim 11, wherein said generating comprises generating each DIM to include a directory version parameter for directory information for each associated VM set.

15. The method of claim 14, wherein said generating comprises generating an updated DIM to update the directory version parameter and the directory information for each associated VM set if directory information for any associated VM set is changed.

16. The method of claim 13, wherein said generating comprises generating an updated DIM if a primary flow version is updated for any content multiplex or overhead flow data scope parameter is updated for overhead flows associated with any content multiplex in one or more associated VM sets.

17. The method of claim 12, wherein said generating comprises generating an updated DIM if an overhead flow type to flow identifier mapping is updated for any content multiplex or new overhead flows are added for any content multiplex in one or more associated VM sets.

18. The method of claim 1, wherein said transmitting comprises transmitting a selected IAF over all multiplexes in one or more VM sets for which the associated IAF flow is generated.

19. The method of claim 5, wherein said transmitting comprises transmitting updated AIM and DIM messages as part of associated IAFs whenever either of the AIM and DIM messages is updated.

20. A method for overhead flow data distribution in a multi-frequency network, the method comprising:
generating global overhead (GO) flows that describe overhead data applicable to all content multiplexes in the multi-frequency network;
assigning a separate flow identifier for each GO flow for every content multiplex wherein the assigned flow identifiers are unique across all overhead flows associated with content multiplexes in a VM set; and
transmitting the GO flows over every content multiplex using their assigned flow identifiers.

21. The method of claim 20, wherein said transmitting comprises transmitting GO flows over only one content multiplex in each VM set to optimize bandwidth utilization for the GO flows.

22. A method for overhead flow data distribution in a multi-frequency network, the method comprising:
generating multiplex specific overhead (MSO) flows that describe overhead data applicable to individual content multiplexes in the multi-frequency network;
assigning a separate flow identifier for each MSO flow for every content multiplex wherein the assigned flow identifiers are unique across all overhead flows associated with content multiplexes in a VM set; and
transmitting the MSO flows over their associated multiplexes using their assigned flow identifiers.

23. An apparatus for overhead flow data distribution in a multi-frequency network, the apparatus comprising:
flow generation logic configured to generate initial acquisition flows (IAFs) that describe how content multiplexes are distributed in each local and wide area of the multi-frequency network and provide flow identifiers for overhead flows associated with the content multiplexes; and
output logic configured to transmit the IAFs on pre-assigned flow identifiers.

24. The apparatus of claim 23, wherein said flow generation logic is configured to generate separate IAF flows for wide and local content multiplexes, respectively.

25. The apparatus of claim 23, wherein said flow generation logic is configured to generate a selected IAF flow for each VM set, wherein the selected IAF flow includes information for content multiplexes in the associated VM set.

26. The apparatus of claim 23, wherein said flow generation logic is configured to generate a selected IAF flow for all VM sets in each UM set, wherein the selected IAF flow includes information for content multiplexes associated with all VM sets in the associated UM set.

27. The apparatus of claim 23, wherein said flow generation logic is configured to generate each IAF flow to comprise a separate area identification message (AIM) and a separate directory information message (DIM).

28. The apparatus of claim 23, wherein said output logic is configured to transmit a selected IAF over all multiplexes in one or more VM sets for which the associated IAF flow is generated.

29. The apparatus of claim 27, wherein said output logic is configured to transmit updated AIM and DIM messages as part of associated IAFs whenever either of the AIM and DIM messages is updated.

30. An apparatus for overhead flow data distribution in a multi-frequency network, the apparatus comprising:
means for generating initial acquisition flows (IAFs) that describe how content multiplexes are distributed in each local and wide area of the multi-frequency network and provide flow identifiers for overhead flows associated with the content multiplexes; and
means for transmitting the IAFs on pre-assigned flow identifiers.

31. The apparatus of claim 30, wherein said means for generating comprises means for generating separate IAF flows for wide and local content multiplexes, respectively.

32. The apparatus of claim 30, wherein said means for generating comprises means for generating a selected IAF flow for each VM set, wherein the selected IAF flow includes information for content multiplexes in the associated VM set.

33. The apparatus of claim 30, wherein said means for generating comprises means for generating a selected IAF flow for all VM sets in each UM set, wherein the selected IAF flow includes information for content multiplexes associated with all VM sets in the associated UM set.

34. The apparatus of claim 30, wherein said means for generating comprises means for generating each IAF flow to comprise a separate area identification message (AIM) and a separate directory information message (DIM).

35. The apparatus of claim 30, wherein said means for transmitting comprises means for transmitting a selected IAF over all multiplexes in one or more VM sets for which the associated IAF flow is generated.

36. The apparatus of claim 34, wherein said means for transmitting comprises means for transmitting updated AIM and DIM messages as part of associated IAFs whenever either of the AIM and DIM messages is updated.

37. A computer program product for overhead flow data distribution in a multi-frequency network, the computer program product comprising:
a machine-readable medium comprising:
a first set of codes for causing a computer to generate initial acquisition flows (IAFs) that describe how content multiplexes are distributed in each local and wide area of the multi-frequency network and provide flow identifiers for overhead flows associated with the content multiplexes; and
a second set of codes for causing the computer to transmit the IAFs on pre-assigned flow identifiers.

38. The machine-readable medium of claim 37, wherein said first set of codes are configured to cause the computer to generate separate IAF flows for wide and local content multiplexes, respectively.

39. The machine-readable medium of claim 37, wherein said first set of codes are configured to cause the computer to generate a selected IAF flow for each VM set, wherein the selected IAF flow includes information for content multiplexes in the associated VM set.

40. The machine-readable medium of claim 37, wherein said first set of codes are configured to cause the computer to generate a selected IAF flow for all VM sets in each UM set, wherein the selected IAF flow includes information for content multiplexes associated with all VM sets in the associated UM set.

41. The machine-readable medium of claim 37, wherein said first set of codes are configured to cause the computer to generate each IAF flow to comprise a separate area identification message (AIM) and a separate directory information message (DIM).

42. The machine-readable medium of claim 37, wherein said second set of codes are configured to cause the computer to transmit a selected IAF over all multiplexes in one or more VM sets for which the associated IAF flow is generated.

43. The machine-readable medium of claim 41, wherein said second set of codes are configured to cause the computer to transmit updated AIM and DIM messages as part of associated IAFs whenever either of the AIM and DIM messages is updated.

44. At least one integrated circuit configured to perform overhead flow data distribution in a multi-frequency network, the at least one integrated circuit comprising:
a first module configured to generate initial acquisition flows (IAFs) that describe how content multiplexes are distributed in each local and wide area of the multi-frequency network and provide flow identifiers for overhead flows associated with the content multiplexes; and
a second module configured to transmit the IAFs on pre-assigned flow identifiers.

45. The at least one integrated circuit of claim 44, wherein said first module is configured to generate separate IAF flows for wide and local content multiplexes, respectively.

46. The at least one integrated circuit of claim 44, wherein said first module is configured to generate a selected IAF flow for each VM set, wherein the selected IAF flow includes information for content multiplexes in the associated VM set.

47. The at least one integrated circuit of claim 44, wherein said first module is configured to generate a selected IAF flow for all VM sets in each UM set, wherein the selected IAF flow includes information for content multiplexes associated with all VM sets in the associated UM set.

48. The at least one integrated circuit of claim 44, wherein said first module is configured to generate each IAF flow to comprise a separate area identification message (AIM) and a separate directory information message (DIM).

49. The at least one integrated circuit of claim 44, wherein said first module is configured to transmit a selected IAF over all multiplexes in one or more VM sets for which the associated IAF flow is generated.

50. The at least one integrated circuit of claim 48, wherein said first module is configured to transmit updated AIM and DIM messages as part of associated IAFs whenever either of the AIM and DIM messages is updated.

51. A method for overhead flow data acquisition in a multi-frequency network, the method comprising:
receiving initial acquisition flows (IAFs) that describe how content multiplexes are distributed in wide and local areas of the multi-frequency network, and specify flow identifiers for overhead flows associated with the content multiplexes, wherein the IAFs are received using pre-assigned flow identifiers;
processing the IAFs to determine VM sets associated with current wide and local areas of the multi-frequency network, and to determine overhead flow related information associated with selected content multiplexes in the VM sets; and
acquiring overhead flow data associated with the selected content multiplexes using the associated flow identifiers.

52. The method of claim 51, wherein said receiving comprises receiving a separate wide IAF for wide content multiplexes and a separate local IAF for local content multiplexes.

53. The method of claim 51, wherein said receiving comprises receiving a separate area identification message (AIM) and a separate directory information message (DIM) as part of each IAF.

54. The method of claim 53, wherein said processing comprises determining a current wide VM set to be a selected wide VM set from an AIM received in a wide IAF and wherein the selected wide VM set is associated with a current wide infrastructure identifier.

55. The method of claim 53, wherein said processing comprises determining a current local VM set to be a selected local VM set from an AIM received in a local IAF and wherein the selected local VM set is associated with a current local infrastructure identifier.

56. The method of claim 53, wherein said processing comprises determining that a particular AIM includes only one VM set and setting a current VM set to be the one VM set included in the particular AIM.

57. The method of claim 53, wherein said processing comprises:
determining that an area version parameter is updated for one or more currently stored VM sets; and
determining new current VM sets using current infrastructure identifiers and information received in associated AIM messages.

58. The method of claim 53, wherein said processing comprises processing received DIM messages to determine directory information comprising overhead flow identifiers and an overhead flow data scope parameter for the overhead flows, and version information for primary flows associated with content multiplexes in current VM sets.

59. The method of claim 58, wherein said processing comprises determining updated directory information for current VM sets if directory information has been updated as indicated by associated directory versions.

60. The method of claim 58, wherein said acquiring comprises acquiring primary flows for those content multiplexes for which no overhead flow data is stored and for those content multiplexes for which an updated primary flow version is received.

61. The method of claim 60, wherein said acquiring comprises acquiring flow data for global overhead (GO) flows and multiplex specific overhead (MSO) flows which have been updated as indicated by version information received in primary flows associated with content multiplexes in current VM sets.

62. The method of claim 61, wherein acquiring further comprises optimizing acquisition of the GO flows by acquiring the GO flows from only one of the multiplexes in the current VM sets.

63. An apparatus for overhead flow data acquisition in a multi-frequency network, the apparatus comprising:
receiving logic configure to receive initial acquisition flows (IAFs) that describe how content multiplexes are distributed in wide and local areas of the multi-frequency network, and specify flow identifiers for overhead flows associated with the content multiplexes, wherein the IAFs are received using pre-assigned flow identifiers; and
processing logic configured to process the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

64. The apparatus of claim 63, wherein said receiving logic is configured to receive a separate wide IAF for wide content multiplexes and a separate local IAF for local content multiplexes.

65. The apparatus of claim 63, wherein said receiving logic is configured to receive a separate area identification message (AIM) and a separate directory information message (DIM) as part of each IAF.

66. The apparatus of claim 65, wherein said processing logic is configured to process received DIM messages to determine directory information comprising overhead flow identifiers and an overhead flow data scope parameter for overhead flows, and version information for primary flows associated with content multiplexes in current VM sets.

67. The apparatus of claim 66, wherein said receiving logic is configured to acquire primary flows for those content multiplexes for which no overhead flow data is stored and for those content multiplexes for which an updated primary flow version is received.

68. The apparatus of claim 67, wherein said receiving logic is configured to acquire flow data for global overhead (GO) flows and multiplex specific overhead (MSO) flows which have been updated as indicated by version information received in primary flows associated with content multiplexes in current VM sets.

69. An apparatus for overhead data acquisition in a multi-frequency network, the apparatus comprising:
means for receiving initial acquisition flows (IAFs) that describe how content multiplexes are distributed in wide and local areas of the multi-frequency network, and specify flow identifiers for overhead flows associated with the content multiplexes, wherein the IAFs are received using pre-assigned flow identifiers; and
means for processing the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

70. The apparatus of claim 69, wherein said means for receiving comprises means for receiving a separate wide IAF for wide content multiplexes and a separate local IAF for local content multiplexes.

71. The apparatus of claim 69, wherein said means for receiving comprises means for receiving a separate area identification message (AIM) and a separate directory information message (DIM) as part of each IAF.

72. The apparatus of claim 71, wherein said means for processing comprises means for processing received DIM messages to determine directory information comprising overhead flow identifiers and an overhead flow data scope parameter for overhead flows, and version information for primary flows associated with content multiplexes in current VM sets.

73. The apparatus of claim 72, wherein said means for receiving comprises means for acquiring primary flows for those content multiplexes for which no overhead flow data is stored and for those content multiplexes for which an updated primary flow version is received.

74. The apparatus of claim 73, wherein said means for receiving comprises means for acquiring flow data for global overhead (GO) flows and multiplex specific overhead (MSO) flows which have been updated as indicated by version information received in primary flows associated with content multiplexes in current VM sets.

75. A computer program product for overhead flow data acquisition in a multi-frequency network, the computer program product comprising:
a machine-readable medium comprising:
a first set of codes for causing a computer to receive initial acquisition flows (IAFs) that describe how content multiplexes are distributed in wide and local areas of the multi-frequency network, and specify flow identifiers for overhead flows associated with the content multiplexes, wherein the IAFs are received using pre-assigned flow identifiers; and
a second set of codes for causing the computer to process the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

76. The machine-readable medium of claim 75, wherein said first set of codes is configured to cause the computer to receive a separate wide IAF for wide content multiplexes and a separate local IAF for local content multiplexes.

77. The machine-readable medium of claim 75, wherein said first set of codes is configured to cause the computer to receive a separate area identification message (AIM) and a separate directory information message (DIM) as part of each IAF.

78. The machine-readable medium of claim 77, wherein said second set of codes is configured to cause the computer to process received DIM messages to determine directory information comprising overhead flow identifiers and an overhead flow data scope parameter for overhead flows, and version information for primary flows associated with content multiplexes in current VM sets.

79. The machine-readable medium of claim 78, wherein said first set of codes is configured to cause the computer to acquire primary flows for those content multiplexes for which no overhead flow data is stored and for those content multiplexes for which an updated primary flow version is received.

80. The machine-readable medium of claim 79, wherein said first set of codes is configured to cause the computer to acquire flow data for global overhead (GO) flows and multiplex specific overhead (MSO) flows which have been updated as indicated by version information received in primary flows associated with content multiplexes in current VM sets.

81. At least one integrated circuit configured to perform overhead flow data acquisition in a multi-frequency network, the at least one integrated circuit comprising:
a first module configured to receive initial acquisition flows (IAFs) that describe how content multiplexes are distributed in wide and local areas of the multi-frequency network, and specify flow identifiers for overhead flows associated with the content multiplexes, wherein the IAFs are received using pre-assigned flow identifiers; and
a second module configured to process the IAFs to determine VM sets associated with current wide and local areas of the multi-frequency network, to determine overhead flow related information associated with selected content multiplexes in the VM sets, and acquire overhead flow data associated with the selected content multiplexes using the associated flow identifiers.

82. The at least one integrated circuit of claim 81, wherein said first module is configured to receive a separate wide IAF for wide content multiplexes and a separate local IAF for local content multiplexes.

83. The at least one integrated circuit of claim 81, wherein said first module is configured to receive a separate area identification message (AIM) and a separate directory information message (DIM) as part of each IAF.

84. The at least one integrated circuit of claim 83, wherein said second module is configured to process received DIM messages to determine directory information comprising overhead flow identifiers and an overhead flow data scope parameter for overhead flows, and version information for primary flows associated with content multiplexes in current VM sets.

85. The at least one integrated circuit of claim 84, wherein said first module is configured to acquire primary flows for those content multiplexes for which no overhead flow data is stored and for those content multiplexes for which an updated primary flow version is received.

86. The at least one integrated circuit of claim 85, wherein said first module is configured to acquire flow data for global overhead (GO) flows and multiplex specific overhead (MSO) flows which have been updated as indicated by version information received in primary flows associated with content multiplexes in current VM sets.
